(19) United States
(12) Patent Application Publication
(10) Pub. No.: US 2017/0143176 A1
(43) Pub. Date: May 25, 2017

(54) ELECTRICAL CONNECTOR FOR A SURFACE CLEANING APPARATUS

(71) Applicant: TECHTRONIC INDUSTRIES CO. LTD., Kwai Chung (CN)

(72) Inventor: Thomas Robert Harries, West Midlands (GB)

(21) Appl. No.: 15/323,453

(22) PCT Filed: Jul. 9, 2015
(86) PCT No.: PCT/GB2015/051987

§ 371 Date: Jan. 3, 2017

(30) Foreign Application Priority Data
Jul. 9, 2014 (GB) 1412206.3

(51) Int. Cl. A47L 9/24; A47L 11/40; H01R 39/10; A47L 9/28

(52) U.S. Cl. CPC A47L 9/246; A47L 9/2868; A47L 11/4002; H01R 39/10

(57) ABSTRACT

A connector for connecting a suction member to a surface cleaning apparatus, the connector comprising a tubular body having a distal end configured to receive and retain the suction member and a proximal end configured to receive an outlet of the apparatus. The tubular body is provided with an external rotatable sleeve member, the rotatable sleeve member is provided with at least one projection configured to engage a corresponding formation of the outlet of the apparatus and form a rotatable snap-fit connection between the connector and the outlet, and at least one electrical connection ring located about the proximal end of the connector configured to contact at least one corresponding electrical connector of the outlet to transmit electrical power from the apparatus to the suction member.

### CROSS-REFERENCE TO RELATED APPLCIATIONS

This application is a U.S. National Phase of International Patent Application No. PCT/GB2015/051987, filed Jul. 9, 2015, which claims priority to GB 1412206.3, filed Jul. 9, 2014, the entire contents of both of which are hereby incorporated by referenced herein.

### BACKGROUND

The present invention relates generally to a surface cleaning apparatus, for example a suction cleaner, and in particular a connector for connecting a suction member to a suction cleaning apparatus.

Suction cleaners are well known appliances, utilizing a suction airflow to draw dust and other matter from whatever is being cleaned. The airflow passes through a dust separator and collector wherein dust entrained in the suction airflow is separated from the airflow and retained for later disposal. For effective cleaning, a high rate of airflow is required. To create this a cleaner requires a powerful suction source in the form of a fan or impeller capable of creating the high airflow and a correspondingly powerful electric motor to drive the fan.

Many suction cleaners provide for the attachment of a suction member, for example a flexible hose or a wand, to the suction cleaner. The attachment of a suction member may assist the user in the removal of dust or other types of debris from various surfaces that may be difficult to reach with the suction cleaner alone.

When connecting a suction member to a suction cleaner, removable means of connection are known, for example snap-fit types of connections.

EP1204362 B1 relates to a snap-fit type hose connector for a vacuum cleaner including a socket having a sleeve, in which the end of a hose is detachably held. The connector includes slidable collar having a retaining surface which runs axially on the sleeve. The collar is displaceable axially in both opposing directions about a neutral axial position.

U.S. Pat. No. 6,334,233 relates to a vacuum cleaner with snap-fit handle connection. The handle section includes an open base portion that includes one or more slots therein and a handle mounting portion includes one or more integral tabs. The one or more slots in the handle section receive the one or more tabs of the handle mounting portion in snap-fit engagement.

DE102007039810 relates to a plug-in vacuum cleaner hose arrangement for detachably connecting two hose parts. The arrangement has a hose plug-in end including a control surface that moves a clip body together with a collar piece relative to a protected area in a pull-out direction during pull-out of the hose plug-in end from a socket. Another clip unit is formed as latching cams by the hose plug-in end, where the latching cams are arranged at an outer periphery of hoses. A hose axial guiding groove is formed at a side of the socket, and the latching cams are engaged in the groove to prevent relative rotation of the hoses.

However, such removable connections, specifically connections of the snap-fit nature, have not been used in combination with a means of transmitting electrical power from a suction cleaner to a suction member.

### SUMMARY

The term “spring-loaded” as used in this description and as known in the art, is meant to embrace for example, a member that is biased or secured by means of spring tension or compression.

The term “suction member” as used in this description is meant to embrace common suction cleaner attachments and may include hose attachments, brush attachments, hard floor brush attachments, hard tube attachments, or wands. The term “external attachment” as used in this description is meant to embrace common suction member attachments such as various floor tools, suction wands, crevice cleaners, light sources, or micro-attachments. Other types of suction members and external attachment will be appreciated by the skilled person.

As is also known in the art, the term “snap-fit” when used in this description is meant to embrace connection means “where part-to-part attachment is accomplished with locating and locking features (constraint features) that are homogenous with one or the other of the components being joined. Joining requires the (flexible) locking features to move aside for engagement with the mating part, followed by return of the locking feature toward its original position to accomplish the interference required to latch the components together. Locator features, the second type of constraint feature, are inflexible, providing strength and stability in the attachment.” See The First Snap-Fit Handbook, Bonenberger, 2000.

As will be appreciated by the skilled person, snap-fit connections may include plastic connection components, plastic-metal connection components, and metal connection components. Materials selected will vary depending on the targeted use.

The term “electrical connection ring” as used in this description is meant to embrace an electromechanical device that allows the transmission of power and electrical signal from a stationary to a rotating structure, such as a slip ring. However, the skilled person will appreciate other types of electrical connection rings that may be used.

The term “electrical connector” as used in this description is meant to embrace electro-mechanical devices for joining electrical circuits. Electrical connectors may include filament brushes, brush pads, roll rings, or electrodes. The skilled person will appreciate other types of electrical connectors that may be used.

A common problem associated with many current connectors used for coupling a suction member to suction cleaner includes the coiling of the suction member when in use. This is likely attributed to the lack of the ability of the connector to rotate. Thus, it is desirable to provide a means of connecting a hose to a suction cleaner that facilitates 360° rotation of the connector whilst maintaining a connection with the outlet.

A further issue that arises with current connectors is a lack of the ability to transmit electrical power from the suction cleaner to the suction member. In many cases, the suction member may be attached to a floor tool, for example a rotating brush or a light source, or the suction member may utilize some sort of power button or on/off switch, all of which may require electrical power to the suction member. Thus, an arrangement in which a connector is used to facilitate electrical contact between a suction cleaner and suction member via an electrical connection along the assembly of a suction member is desirable. It is also desirable to provide an arrangement in which a connector is used to facilitate electrical contact between a suction cleaner and suction member via an electrical connection along the assembly of a suction member that also allows for rotation of the connector whilst maintaining a connection with the outlet.

With regard to providing an electrical connection between the suction member and suction cleaner via a connector, it is further desirable to provide a connector that limits user exposure to electrical components within the connector, and thus eliminates the possibility of user electric shock.

Another safety concern associated with suction cleaner use, particularly vacuum cleaners, is user electrocution as a result of a user pulling the electrical cord of a vacuum cleaner and removing the vacuum cleaner plug from its electrical socket without having turned the vacuum off.

Therefore, if the user is using a suction member, such as a hose, and notices that the vacuum cleaner cord is taut, and/or the plug is on the brink of being pulled from its electrical socket, it would be beneficial to provide a means for quickly turning the vacuum cleaner off. As mentioned above, this may be accomplished via a power button on the suction member, which would enable a user to ensure that the vacuum cleaner is turned off before the plug is pulled from the electrical socket, thus preventing user electrocution.

The present invention provides a means for a user to removably and securely attach a suction member, such as a hose, wand, or conduit, to a suction cleaner via a “snap-fit” type of connection. The invention provides, together with a removable connection means, an electrical connection between the suction member and suction cleaner that is concealed to prevent user electrocution, while also allowing for 360° rotation of the connector whilst maintaining a connection with the outlet.

According to the present invention, there is provided a connector for connecting a suction member to a surface cleaning apparatus, the connector comprising a tubular body having a distal end configured to receive and retain the suction member and a proximal end configured to receive an outlet of the apparatus, wherein the tubular body is provided with an external rotatable sleeve member, wherein the rotatable sleeve member is provided with at least one projection configured to engage a corresponding formation of the outlet of the apparatus and form a rotatable snap-fit connection between the connector and the outlet, and at least one electrical connection ring located about the proximal end of the connector configured to contact at least one corresponding electrical connector of the outlet to transmit electrical power from the apparatus to the suction member.

Preferably, the external sleeve member comprises a ring comprising the at least one projection, the projection or projections project inwardly from the rotatable sleeve member towards the tubular body.

Conveniently, the formation of the outlet is a circumferential lip located about the outlet, preferably located about the end of the outlet that is remote from the apparatus.

Advantageously, the distal end of the tubular body is tapered and preferably provides a push-fit connection to retain the suction member.

Preferably, the rotatable sleeve member is resiliently biased toward the outlet, preferably by at least one spring.

Conveniently, the outlet is attached to or formed with the apparatus.

Advantageously, the at least one electrical connection ring is a slip ring.

Preferably, the at least one electrical connector of the outlet is selected from a filament brush, brush pad, roll ring, electrode, or combination thereof.

Conveniently, the rotatable sleeve member includes a portion having reduced diameter that acts as a user graspable handle.

Advantageously, the suction member is connected to an external attachment, preferably selected from a floor tool or a light source.

Preferably, the suction member is a hose, wand or conduit.

Conveniently, the apparatus is a vacuum cleaner, and is preferably a cylinder vacuum cleaner, an upright vacuum cleaner, or a hand-held vacuum cleaner.

Advantageously, the at least one electrical connection ring and the at least one corresponding electrical connector of the outlet together complete an electrical circuit.

Preferably, the rotatable sleeve member comprises at least one abutment configured to engage with and exert a force on the at least one projection when the rotatable sleeve member is moved in the direction away from the outlet to disengage the at least one projection and thereby open the snap-fit connection.

### BRIEF DESCRIPTION OF THE DRAWINGS

Embodiments of the invention are described below by way of example with reference to the accompanying drawings in which:

FIG. 1 is a side perspective view of an arrangement according to the present invention;

FIG. 2 is a further side perspective view of the arrangement of FIG. 1;

FIG. 3 is a cross-sectional view of an outlet and a connector of the invention, with a suction member;

FIGS. 4a and 4b are cross-sectional views of a further arrangement of the present invention;

FIGS. 5a to 5c are cross-sectional views of the snap-fit connection of the invention;

FIG. 6 is a cross-sectional view of the electrical connection ring of the invention;

FIG. 7 is a cross-sectional view of a further arrangement of the present invention.

### DETAILED DESCRIPTION

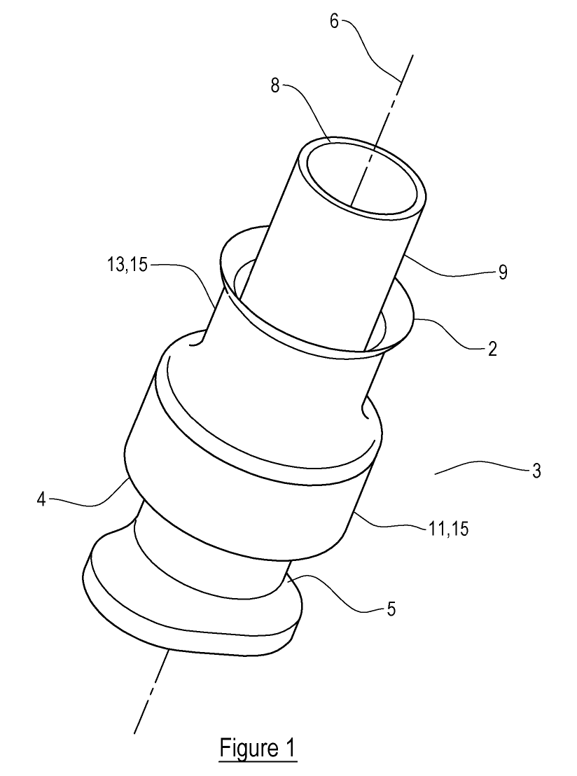

FIG. 1 depicts an advantageous arrangement according to the present invention, wherein a connector 3 facilitates the connection of a suction member 9 to an outlet 5 that is preferably attached to or formed with a surface cleaning apparatus. The distal end of the connector 2 is configured for receiving and retaining a suction member 9, for example a hose, wand or conduit. The connector 3 comprises a rotatable sleeve member 15 that preferably comprises a first outer section 13, wherein the first section 13 is of reduced diameter and a second outer section 11. In preferred arrangements of the present invention, the first outer section 13 acts as a user graspable handle. The rotatable sleeve member 15 is rotatable about a longitudinal axis 6 of the connected arrangement. The circular shape of the connector 3 allows for rotation of the connector 3 about the outlet 5 whilst the connector 3 is in connection with the outlet 5.

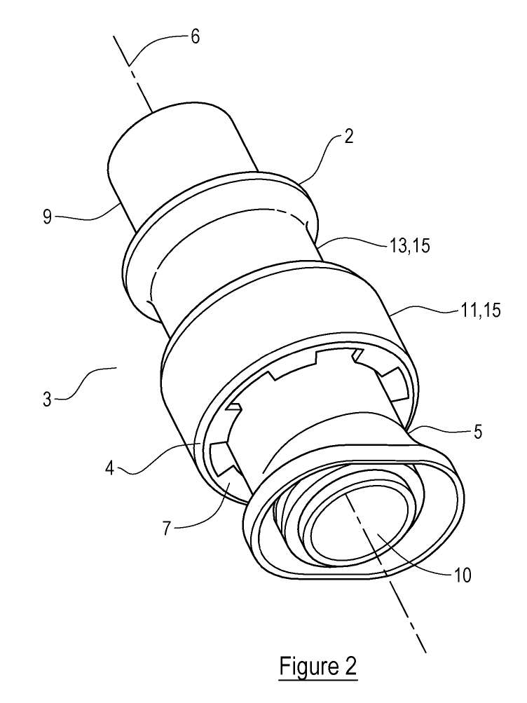

FIG. 2 further illustrates the advantageous arrangement of FIG. 1. At the proximal end of the connector 4, a ring 7 is attached to an inner wall of the rotatable sleeve member 15, and in this particular arrangement is attached to an inner wall of the second section 13. The ring 7 comprises at least one projection 17, and as shown, in preferred arrangements the ring comprises a plurality of projections which are spaced apart from one another. The plurality of projections 17 are flexible and project at an angle toward the sleeve member 15. As will be appreciated from the below discussion, the projections 17 are the flexible locking features that move aside for engagement with the mating part on the outlet, followed by return of the locking features toward their original positions to accomplish the interference required to latch the components together, i.e. the snap fit arrangement, when the connector 3 is attached to the outlet 5. The proximal end of the connector 4 is configured for receiving the outlet 5 that is attached to or formed with a surface cleaning apparatus, for example a vacuum cleaner, via an aperture 10.

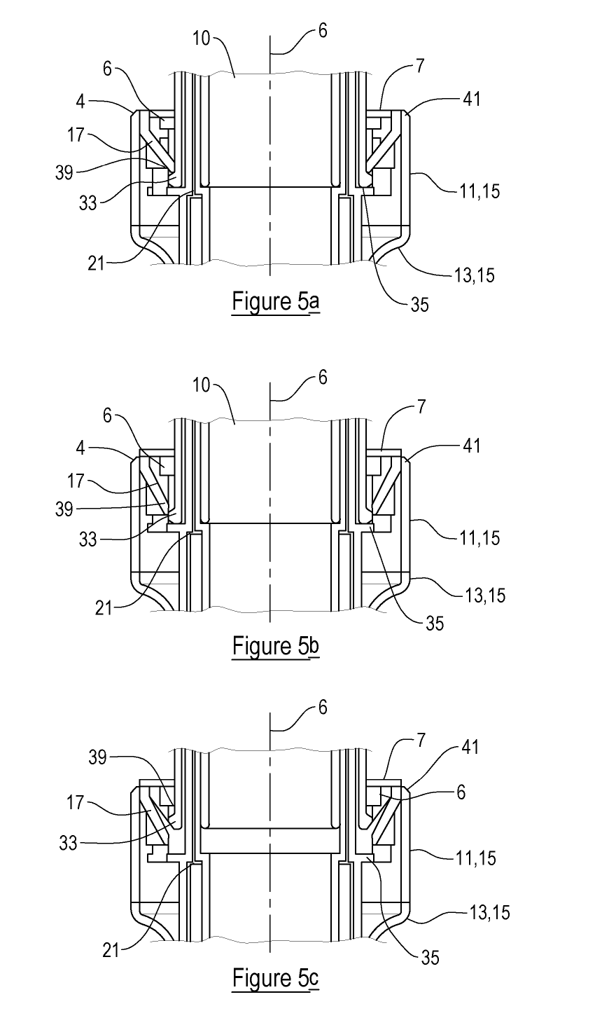

The rotatable sleeve member may be resiliently biased toward the outlet, and is preferably a spring-loaded rotatable sleeve member 15. This prevents the connector from inadvertently being detached from the outlet. Removal of the connector 3 from the outlet 5 is achieved through the use of a at least one abutment 6 on the sleeve that is configured to engage with and exert a force on the at least one projection 17 when the rotatable sleeve member 15 is moved in the direction away from the outlet 5. By pulling the rotatable sleeve member 15 toward the distal end 2 of the connector 3, the abutment 6 forces the at least one projection 17 to flex and disengage from the formation 33 of the outlet 5, thereby creating a clearance gap 43 for opening of the snap-fit connection (FIGS. 5b and 5c).

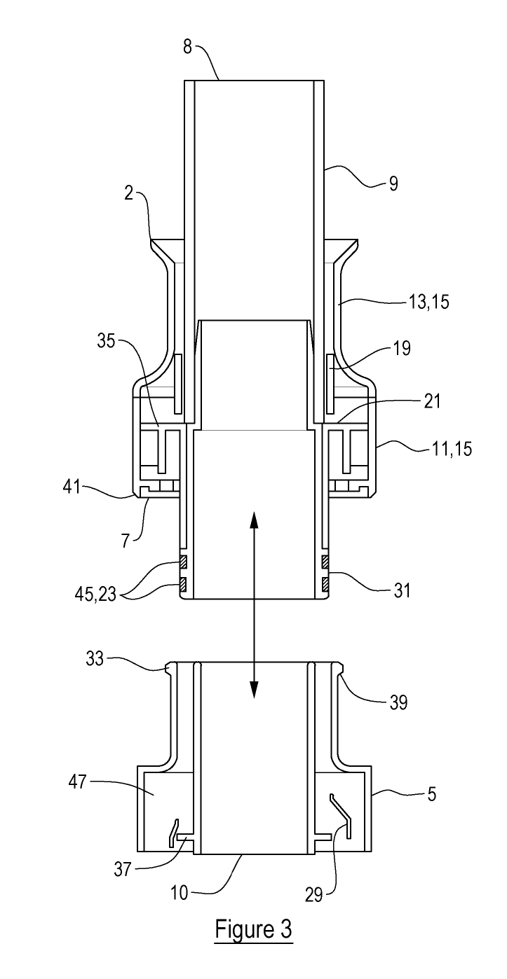

FIG. 3 illustrates a detached arrangement of a suction member 9 contained within a tubular body 19 of the connector 3, and an outlet 5 that is in connection with a suction cleaning apparatus. The tubular body 19 within the connector 3 is configured for receiving and retaining the suction member 9 within the distal end 2 of the connector, and is preferably tapered in order to provide a push-fit connection to retain the suction member. As can be seen in FIG. 3, the suction member 9 is located in a position within the connector 3 to allow for contact at a contact location 21 with the electrical connection ring 23 located about the proximal end 4 of the connector.

In preferred embodiments of this invention, and as depicted in FIG. 3, the electrical connection ring 23 is a slip ring and the slip ring is mounted to a slip ring mount 31. However, the use of alternative forms of electrical connection rings is possible and will be appreciated by one of skill in the ar

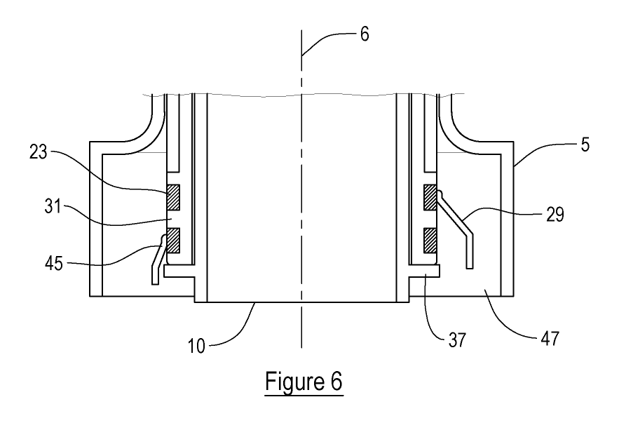

The electrical connection ring 23 located about the proximal end 4 of the connector 3 is configured to engage with the outlet 5 upon attachment of the connector 3 to the outlet 5. In preferred arrangements of the present invention, once inserted into the outlet 5, the electrical connection ring 23, which encircles the connector, will contact the at least one electrical connector 29 housed within the outlet 5. The electrical connection ring is located in positions within the outlet that allow the electrical connector(s) 29 and the electrical connection ring 23 to complete an electrical circuit (FIG. 6). The housing of the electrical connectors 29 within the outlet 5 prevents user exposure to the electrical connection between the electrical connection ring 23 and the electrical connectors 29.

In preferred arrangements of the present invention, the electrical connectors 29 may be filament brushes, brush pads, roll rings, or electrodes. Other types of electrical connectors are known and will be appreciated by one of skill in the art.

According to another preferred arrangement of the present invention, the formation 33 of the outlet 5 (the non-flexible second locator part of the snap-fit connection) is a circumferential lip that engages with the projections 17 of the ring 7. The ring is attached to the inner wall of the rotatable sleeve member 15 (FIGS. 5a-5c).

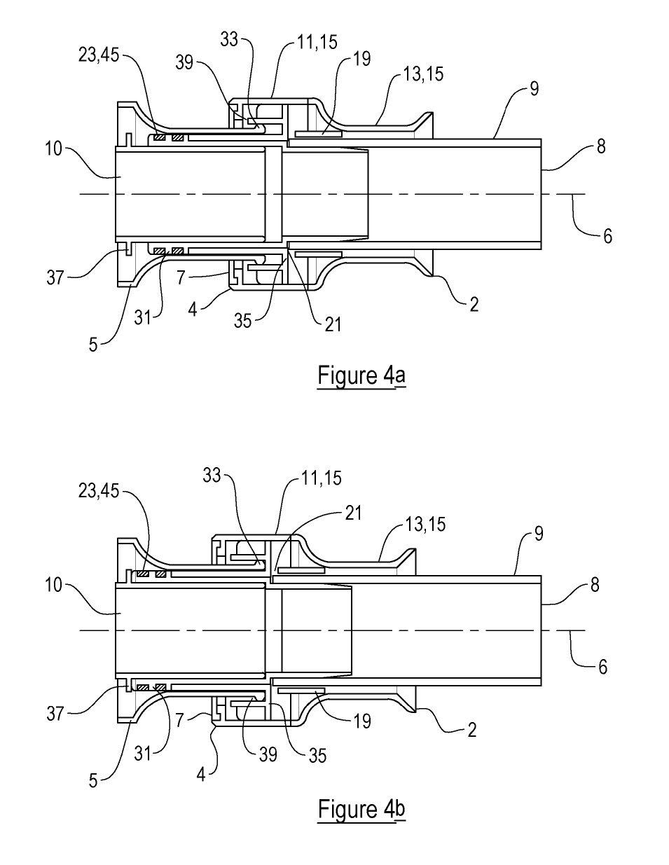

FIGS. 4a and 4b illustrate the snap-fit connection of a connector 3 containing a suction member 9 to an outlet 5 that is preferably attached to or formed with a surface cleaning apparatus. As can be seen in both FIGS. 4a and 4b, in a preferred arrangement of the present invention, the electrical connection ring 23 is housed within the outlet 5.

FIG. 4a depicts the alignment of the formation 33 of the outlet 5 that engages with the rotatable sleeve member prior to snap-fitting the connector to the outlet. FIG. 4b depicts the locked, snap-fit configuration of the formation 33 of the outlet 5 engaging with the at least one projection located within and projecting inwardly from the sleeve member of the connector 3.

Upon the snap-fit, the formation 33 of the outlet 5, which is preferably a circumferential lip, urges past the ring 7 and at least one projection 17 located and attached to the rotatable sleeve member 15 of the connector 3. As shown in FIG. 4b, according to a preferred arrangement of the present invention, once the outlet 5 and connector 3 are in the snap-fit configuration, the formation 33 of the outlet 5 abuts a wall 35 within the rotatable sleeve member 15 of the connector 3 and the electrical connection ring 23 abuts a wall 37 within the outlet 5, thus preventing further forward movement of both the formation 33 of the outlet 5 and the electrical connection ring 23.

FIGS. 5a-5c illustrate the progression of the opening of the snap-fit connection between the outlet 5 and the connector 3.

FIG. 5a illustrates the locked position of the formation 33 of the outlet 5 and the at least one projection 17 attached to the rotatable sleeve member 15 of the connector 3. The snap-fit connection provides secure, removable attachment of the outlet 5 to the connector 3. After having flexed toward the distal end 2 of the connector 3 upon the urging contact from the formation 33 of the outlet 5, and after the formation 33 of the outlet 5 has passed over the at least one projection 17, the at least one projection 17 may flex back to its initial position and rest against a radially extending surface 39 of formation 33 of the outlet 5.

In a preferred arrangement of the present invention, as is illustrated in FIGS. 5a-5c, the rotatable sleeve member 15 is attached to a lower portion 41 of the at least one projection 17 and the rotatable sleeve member comprises at least one abutment 6 that is configured to engage with and exert a force on the at least one projection 17 when the rotatable sleeve member 15 is moved in the direction away from the outlet 5. This allows the at least one projection 17 to disengage the formation 33 and thereby open the snap-fit connection. This particular arrangement is beneficial if the rotatable sleeve member 15 is, for example, spring-loaded and is able to be pulled back by the user toward the distal end 2 of the connector 3.

As can be seen in FIG. 5b, pulling the rotatable sleeve member 15 back toward the distal end 2 of the connector 3 results in the at least one projection 17 moving out of the path of the formation 33 of the outlet 5, thereby creating a clearance gap 43 for the opening of the snap-fit connection.

FIG. 5c depicts an arrangement wherein the connector 3 and outlet 5 have been detached and are able to move freely from one another. The formation 33 has moved past the at least one projection 17, thus increasing the size of the clearance gap 43, allowing the outlet 5 to be withdrawn from the connector 3. The at least one projection 17 is then able to flex forward and return to its initial position.

FIG. 6 illustrates the contact between the electrical connection ring 23 of the connector 3 and the electrical connectors 29 that are preferably housed within the outlet 5. In this particular arrangement, the electrical connection ring 23 is a slip ring and mounted on a slip ring mount 31. Preferably, the electrical connectors 29 are selected from filament brushes, brush pads, roll rings, or electrodes.

The electrical connection ring 23 contains at least two points of contact 45 for interaction with the electrical connectors 29 of the outlet 5. As can be seen in the figure, the electrical connectors 29 may be housed within a void 47 of the outlet 5.

In a preferred arrangement of the present invention, as is illustrated in FIG. 6, the outlet 5 may gradually increase in diameter in the direction toward the suction cleaning apparatus, thereby providing a void 47 for housing the electrical connectors 29 and allowing for the electrical connection ring 23 to rotate within the outlet 5. As previously mentioned, housing of the electrical connectors 29 within the outlet 5 also prevents user exposure to the electrical connection between the electrical connection ring 23 and the electrical connectors 29.

The benefit of using an electrical connection ring 23 in the present invention, for example a slip ring, is that upon rotation of the electrical connection ring 23 within the outlet 5, a completed electrical circuit will exist regardless of connector 3 rotation about the outlet. In preferred embodiments of this invention, the electrical connection generated may be used to power an external attachment, such as a floor tool or light source, that is attached to the suction member 9 retained within the tubular body 19 of the connector 3.

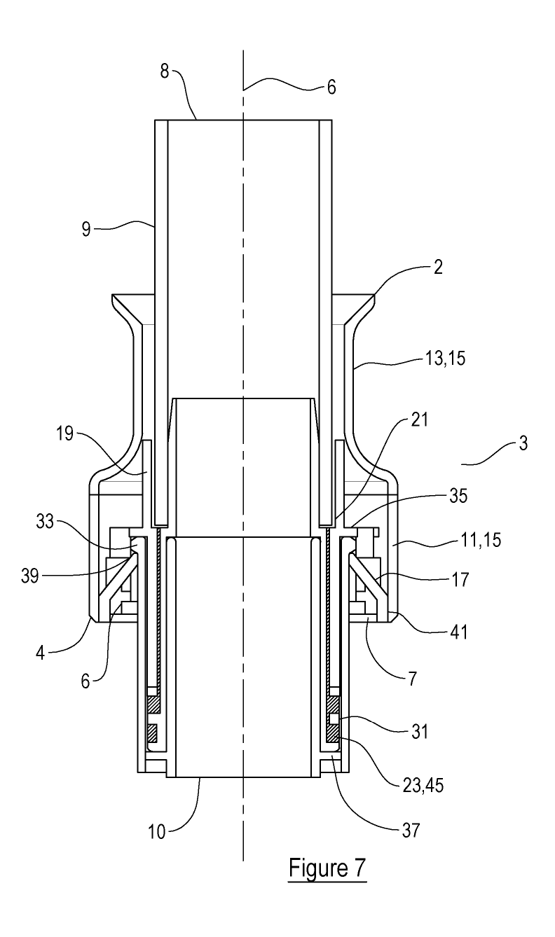

FIG. 7 depicts an advantageous arrangement according to the present invention, wherein the connector 3 connects a suction member 9 to an outlet 5 that is in connection with a surface cleaning apparatus. The distal end of the connector 2 is configured for receiving a suction member 9, such as a hose, wand or conduit. The connector 3 comprises a first outer section 13 of reduced diameter, wherein the first section 13 acts as a user graspable handle to aid, for example, in detachment of the connector 3 from the outlet 5. The circular shape of the connector 3 allows for rotation of the connector 3 about the outlet 5.

The outlet 5 is secured within the connector 3 via a snap-fit connection between the outlet 5 and the at least one projection 17 attached to the rotatable sleeve member 15. As illustrated in FIG. 7, the connector 3 and outlet 5 are attached in the locked configuration, wherein the formation 33 of the outlet 5 abuts a wall 35 within the sleeve member 15 to prevent further forward movement and the at least one projection 17 has flexed to its initial position and rests against the radially extending surface 39 of the formation 33 of the outlet 5.

The connector 3 preferably comprises two outer sections, the first section 13 acting as a user graspable handle. The second section 13 of the rotatable sleeve member 15 is attached to a lower portion 41 of the at least one projection 17.

The electrical connection ring 23 rests within the outlet 5 and is in contact with electrical connectors 29 housed within the void 47 of the outlet 5. Much like the formation 33 of the outlet 5, the electrical connection ring 23 abuts a wall 37 within the outlet 5 to prevent further forward movement of the electrical connection ring 23 within the void 47.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A connector for connecting a suction member to a surface cleaning apparatus, the connector comprising:,
a tubular body having a distal end configured to receive and retain the suction member and a proximal end configured to receive an outlet of the apparatus;
wherein the tubular body is provided with an external rotatable sleeve member;
wherein the rotatable sleeve member is provided with at least one projection configured to engage a corresponding formation of the outlet of the apparatus and form a rotatable snap-fit connection between the connector and the outlet; and
at least one electrical connection ring located about the proximal end of the connector configured to contact at least one corresponding electrical connector of the outlet to transmit electrical power from the apparatus to the suction member.

2. A connector according to claim 1, wherein the external sleeve member comprises a ring comprising the at least one projection, the projection or projections project inwardly from the rotatable sleeve member towards the tubular body.

3. A connector according to claim 1, wherein the formation of the outlet is a circumferential lip located about the outlet.

4. A connector according to claim 1, wherein the distal end of the tubular body is tapered.

5. A connector according to claim 1, wherein the rotatable sleeve member is resiliently biased toward the outlet.

6. A connector according to claim 1, wherein the outlet is attached to or formed with the apparatus.

7. A connector according to claim 1, wherein the at least one electrical connection ring is a slip ring.

8. A connector according to claim 1, wherein the at least one electrical connector of the outlet is selected from a filament brush, brush pad, roll ring, electrode, or combination thereof.

9. A connector according to claim 1, wherein the rotatable sleeve member includes a portion having reduced diameter that acts as a user graspable handle.

10. A connector according to claim 1, wherein the suction member is connected to an external attachment.

11. A connector according to claim 1, wherein the suction member is a hose, wand or conduit.

12. A connector according to claim 1, wherein the apparatus is a vacuum cleaner.

13. A connector according to claim 1, wherein the at least one electrical connection ring and the at least one corresponding electrical connector of the outlet together complete an electrical circuit.

14. A connector according to claim 1, wherein the rotatable sleeve member comprises at least one abutment configured to engage with and exert a force on the at least one projection when the rotatable sleeve member is moved in the direction away from the outlet to disengage the at least one projection and thereby open the snap-fit connection.

15-16. (canceled)

17. A connector according to claim 3, wherein the formation of the outlet is located about the end of the outlet that is remote from the apparatus.

18. A connector according to claim 4, wherein the distal end of the tubular body provides a push-fit connection to retain the suction member.

19. A connector according to claim 5, wherein the rotatable sleeve member is resiliently biased toward the outlet by at least one spring.

20. A connector according to claim 10, wherein the suction member is connected to a floor tool or a light source.

21. A connector according to claim 12, wherein the apparatus is one of a cylinder vacuum cleaner, an upright vacuum cleaner, or a hand-held vacuum cleaner.
